(19) United States
(12) Patent Application Publication
(10) Pub. No.: US 2026/0225026 A1
(43) Pub. Date: Aug. 6, 2026

(54) CARBON DIOXIDE CAPTURE SYSTEM USING A LIQUID DESICCANT, AND METHODS THEREOF

(71) Applicant: Avnos, Inc., Los Angeles, CA (US)

(72) Inventors: Yanhui Yuan, Erie, CO (US); Jason K. Ward, Fort Mill, SC (US); Benjamin A. McCool, Annandale, NJ (US)

(21) Appl. No.: 19/530,128

(22) Filed: Feb. 4, 2026

Related U.S. Application Data
(60) Provisional application No. 63/754,405, filed on Feb. 5, 2025.

(51) Int. Cl. B01D 53/04; B01D 53/14; B01D 53/26; B01D 61/36; C01B 5/00; C01B 32/50

(52) U.S. Cl. CPC B01D 53/0438; B01D 53/1425; B01D 53/263; B01D 61/362; C01B 5/00; C01B 32/50; B01D 2257/504; B01D 2257/80; B01D 2258/06; B01D 2259/4009

(57) ABSTRACT

Systems and methods for providing carbon dioxide direct air capture (DAC) systems to improve energy efficiency, operability, and economic performance of DAC technologies based on several types of approaches including moisture swing adsorption (MSA) are disclosed. In particular, DAC systems including an absorber unit, a carbon capture unit, a water vapor-generating unit, and a liquid desiccant regenerating unit are disclosed.

### INCORPORATION BY REFERENCE TO ANY PRIORITY APPLICATIONS

Any and all applications for which a priority claim is identified in the Application Data Sheet as filed with the present application are hereby incorporated by reference under 37 CFR 1.57.

### FIELD

The present disclosure relates to the field of direct air capture (DAC) for capturing carbon dioxide (CO₂) from ambient air.

### BACKGROUND

Direct air capture (DAC) refers to the use of chemical or physical processes and corresponding systems to extract carbon dioxide from the ambient air. In general, a DAC system includes a carbon dioxide sorbent that adsorbs carbon dioxide from ambient air and then, in response to an external stimulus, releases carbon dioxide, thereby regenerating the sorbent. Several types of DAC systems are known. They include temperature swing adsorption (TSA) units, whereby temperature induces carbon dioxide release, pressure swing adsorption (PSA) units, whereby pressure induces carbon dioxide release, and moisture swing adsorption (MSA) units, whereby moisture contacting the sorbent induces carbon dioxide release.

Conventional DAC systems require energy and capital expenditure intensive components, and labor intensive maintenance to sustain economically reasonable DAC operability. Moreover, some of the most advanced MSA-DAC systems include atmospheric water harvesting and water management equipment, and involve significant capital outlay. As such, improved carbon dioxide capture systems are desired.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In some aspects, a system is described. The system includes: an absorber unit comprising a liquid desiccant configured to receive an ambient air stream comprising water and carbon dioxide, and to absorb water from the ambient air stream to form a first stream having a water content less than the water content of the ambient air stream and a second stream comprising water and the liquid desiccant, a carbon capture unit downstream of the absorber unit configured to receive the first stream, the carbon capture unit comprising a moisture swing adsorbent configured to reversibly operate in capture mode to adsorb water and carbon dioxide from the first stream and produce a carbon dioxide-depleted dried air stream and regeneration mode to release adsorbed water and carbon dioxide to produce a third stream, a water vapor-generating unit in communication with the carbon capture unit configured to deliver a water vapor stream to the carbon capture unit during regeneration mode, and a liquid desiccant regenerating unit configured to receive the second stream and ambient air, the carbon dioxide-depleted dried air stream from the carbon capture unit in capture mode, or a combination thereof and remove water from the second stream to produce a stream comprising dried liquid desiccant and a humid air stream comprising water removed from the second stream.

In some embodiments, the system further includes a liquid desiccant reservoir downstream of the absorber unit configured to receive the second stream from the absorber unit.

In some embodiments, the water vapor-generating unit includes: a vacuum reboiler comprising a steam reservoir and a heater, wherein the vacuum reboiler is configured to receive the second stream, water generated by the carbon capture unit during regeneration mode, or a combination thereof, convert the water to water vapor, and deliver the water vapor to the carbon capture unit to regenerate the moisture swing adsorbent, a plurality of pervaporation membranes configured to receive the second stream, water generated by the carbon capture unit during regeneration mode, or a combination thereof, convert the water to water vapor, and deliver the water vapor to the carbon capture unit to regenerate the moisture swing adsorbent, or a combination thereof.

In some embodiments, the water vapor-generating unit includes the vacuum reboiler configured to receive the second stream.

In some embodiments, the water vapor-generating unit includes the vacuum reboiler configured to receive water from the carbon capture unit generated during regeneration mode.

In some embodiments, the water vapor-generating unit comprises the plurality of pervaporation membranes.

In some embodiments, the system further includes a separator configured to receive the third stream and produce a carbon dioxide stream and a water stream.

In some embodiments, the system further includes a chiller between the carbon capture unit and the separator.

In some embodiments, the system further includes a steam flash unit configured to receive the water stream from the separator and generate a second water vapor stream.

In some embodiments, the system further includes a dried liquid desiccant reservoir upstream of the absorber unit configured to receive the dried liquid desiccant from the liquid desiccant regenerating unit.

In some aspects, a method for removing water and carbon dioxide from an ambient air stream is described. The method includes: feeding an ambient air stream into an absorber unit comprising a liquid desiccant, wherein the liquid desiccant absorbs water in the ambient air stream to form a first stream having a water content less than the water content of the ambient air stream and a second stream comprising water and liquid desiccant, feeding the first stream to a carbon capture unit comprising a moisture swing adsorbent configured to capture water and carbon dioxide, thereby forming a carbon dioxide-depleted dried air stream, and feeding the second stream and a second ambient air stream or the carbon dioxide-depleted dried air stream from the carbon capture unit to a liquid desiccant regenerating unit, thereby forming a dried liquid desiccant and humid air stream.

In some embodiments, the method further includes regenerating the moisture swing adsorbent in the carbon capture unit by feeding a water vapor stream from a water vapor-generating unit, thereby forming a third stream comprising water and carbon dioxide.

In some embodiments, the method further includes feeding the second stream, water from the third stream, or a combination thereof to the water vapor-generating unit.

In some embodiments, the method further includes feeding the third stream into a separator to form a carbon dioxide stream and a water stream, and feeding the water stream to the water vapor-generating unit or a steam flash unit to form the water vapor stream for regenerating the moisture swing adsorbent.

### BRIEF DESCRIPTION OF THE DRAWINGS

In the following, exemplary embodiments of the present disclosure will be described with reference to the drawings.

FIG. 1 is a schematic illustration of a carbon dioxide capture system employing a liquid desiccant, according to some embodiments.

FIG. 2 is a schematic illustration of a carbon dioxide capture system employing a liquid desiccant and including a liquid desiccant reservoir, according to some embodiments.

FIG. 3 is a schematic illustration of another embodiment of the carbon dioxide capture system employing a liquid desiccant.

FIG. 4 is a schematic illustration of a carbon dioxide capture system employing a liquid desiccant and including a separator and a steam flash unit, according to some embodiments.

FIG. 5 is a schematic illustration of a carbon dioxide capture system employing a liquid desiccant and including a chiller, according to some embodiments.

### DETAILED DESCRIPTION

The present disclosure can be understood more readily by referencing the following detailed description, examples, drawings, and claims, and their previous and following descriptions. However, before the present systems and methods are disclosed and described, it is to be understood that this disclosure is not limited to the specific systems and methods disclosed unless otherwise specified. It is also to be understood that the terminology used herein is for the purpose of describing particular aspects only and is not necessarily intended to be limiting.

The description is provided as an enabling teaching of the disclosure. To this end, those skilled in the relevant art will recognize and appreciate that many changes can be made to the various aspects of the disclosure described herein while still obtaining beneficial results. It will also be apparent that some of the desired benefits can be obtained by selecting some of the features described herein without utilizing other features. Accordingly, those who work in the art will recognize that many modifications and adaptations to the present description are possible and can even be desirable in certain circumstances and are a part of the present disclosure. Thus, this description is provided as illustrative of certain principles of the present disclosure and not in limitation thereof.

Unless defined otherwise, all technical and scientific terms used herein have the same meaning as is commonly understood by one of ordinary skill practicing in the field of the present disclosure.

The disclosed system and process utilizes a liquid desiccation process to dehumidify the incoming air to maximize carbon dioxide adsorption on a moisture swing DAC sorbent. In the adsorption cycle, this system and process eliminates the need for a separate atmospheric water adsorption bed. The ambient air is dried by the absorber unit containing a liquid desiccant, and the dried ambient air is fed into the carbon capture unit for carbon dioxide removal. In the desorption cycle, a water vapor-generating unit in communication with the carbon capture unit is utilized to provide water vapor for regenerating the moisture swing DAC sorbent. A portion of the water-loaded liquid desiccant is fed into the water vapor-generating unit to produce water vapor needed for the sorbent regeneration. In some embodiments, the water-loaded liquid desiccant can be regenerated using carbon dioxide-depleted dried air released from the carbon capture unit operating in carbon capture mode and/or ambient air.

### Carbon Dioxide Capture System Using a Liquid Desiccant

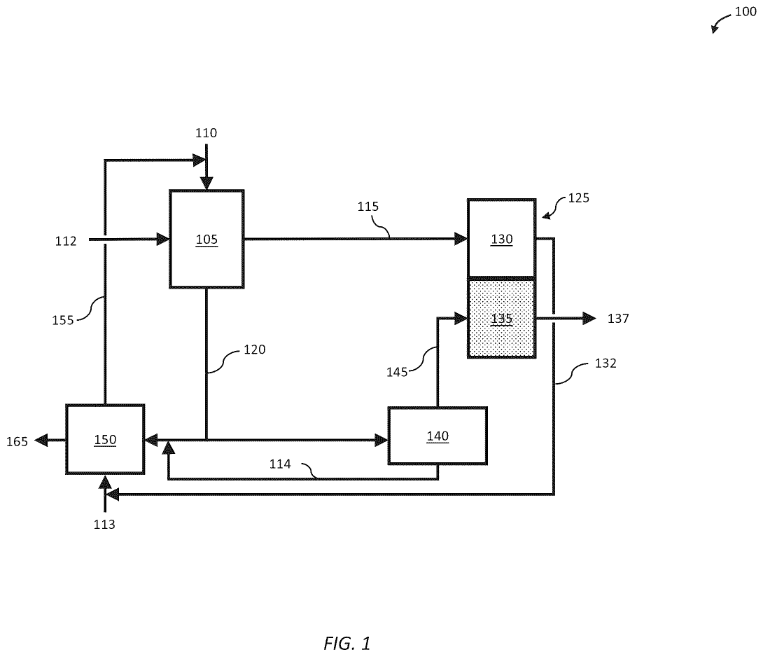

According to the present disclosure, a carbon dioxide capture system includes an absorber unit, a carbon capture unit, a water vapor-generating unit, and a liquid desiccant regenerating unit. FIG. 1 is a schematic illustration of a carbon dioxide capture system 100. As illustrated in FIG. 1, the carbon dioxide capture system 100 includes an absorber unit 105, a carbon capture unit 125, a water vapor-generating unit 140, and a liquid desiccant regenerating unit 150. The absorber unit 105 includes a liquid desiccant 110 and is configured to receive ambient air stream 112 comprising water and carbon dioxide. The liquid desiccant 110 absorbs the water (e.g., some amount of water or a maximum amount of water capable of being absorbed by the liquid desiccant) in the ambient air stream 112 which produces a first stream 115 having a water content less than the water content of the ambient air stream 112 and a second stream 120 comprising the liquid desiccant and the water removed from the ambient air stream 112 (i.e., water-loaded liquid desiccant). The carbon capture unit 125 downstream of the absorber unit 105 is configured to receive the first stream 115 and includes a moisture swing adsorbent configured to reversibly operate in a capture mode 130 and a regeneration mode 135. During the capture mode 130, the carbon capture unit 125 is configured to adsorb water and carbon dioxide from the first stream 115 and produce a carbon dioxide-depleted dried air stream 132.

During the regeneration mode 135, the carbon capture unit 125 is configured to receive water vapor from the water vapor-generating unit 140 and release adsorbed water and carbon dioxide to produce a third stream 137 comprising carbon dioxide and water. The water vapor-generating unit 140 is configured to receive a portion of the second stream 120 and is in communication with the carbon capture unit 125. The water vapor-generating unit 140 is further configured to deliver a water vapor stream 145 to the carbon capture unit 125 during regeneration mode 135. The water vapor-generating unit 140 is also configured to return a water lean liquid desiccant 114 to a liquid desiccant regenerating unit 150. In some embodiments, the water lean liquid desiccant 114 is configured to be delivered to the liquid desiccant regenerating unit 150 via joining the second stream 120.

In some embodiments, the water vapor-generating unit may comprise a vacuum reboiler, a plurality of pervaporation membranes, or a combination thereof. In some embodiments, the water vapor-generating unit may include a steam flash unit, a vertical or horizontal-tube evaporator, an agitated or wiped thin-film evaporator, and a porous or non-porous membrane contactor. The vacuum reboiler may include a steam reservoir and a heater. The vacuum reboiler is configured to receive the second stream 120 and convert the water in the second stream 120 to a water vapor stream 145. The vacuum reboiler is further configured to deliver the water vapor stream 145 to the carbon capture unit 125 to help regenerate the moisture swing adsorbent in the carbon capture unit 125. In some embodiments, where the water vapor-generating unit 140 comprises a plurality of pervaporation membranes, the plurality of pervaporation membranes is configured to receive the second stream 120 and convert the water in the second stream 120 to a water vapor stream 145. The plurality of pervaporation membranes is further configured to deliver the water vapor stream 145 to the carbon capture unit 125 to help regenerate the moisture swing adsorbent. In some embodiments, the water vapor-generating unit may include both the vacuum reboiler and a plurality of pervaporation membranes.

The liquid desiccant regenerating unit 150 is configured to regenerate water-loaded liquid desiccant by removing water from it. The liquid desiccant regenerating unit 150 is configured to receive the second stream 120 and ambient air 113 (i.e., a second ambient air stream) and/or the carbon dioxide-depleted dried air stream 132 produced by the carbon capture unit during the capture mode. With the removal of water from the second stream 120, the liquid desiccant regenerating unit 150 produces a stream comprising dried liquid desiccant 155 and a humid air stream 165 comprising the water removed from the second stream 120.

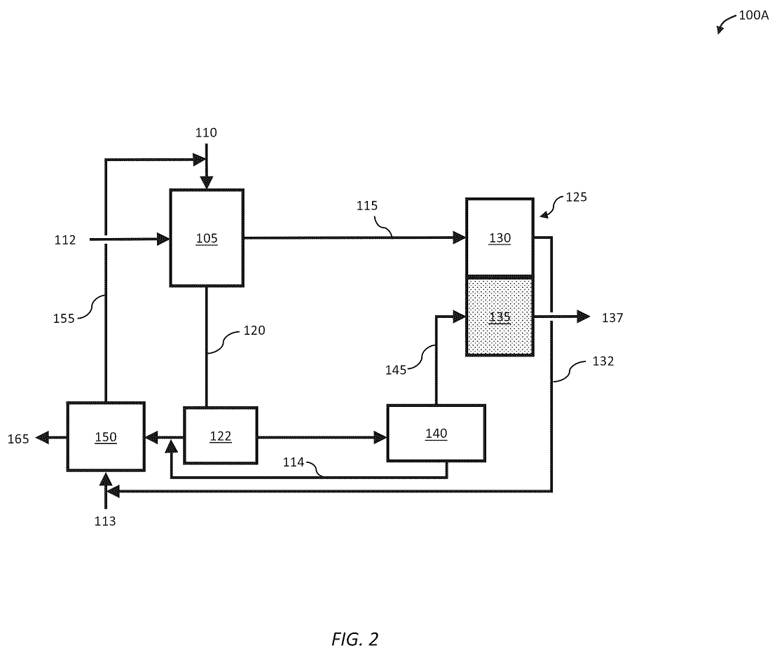

In some embodiments, the carbon dioxide capture system may further comprise a liquid desiccant reservoir. As illustrated in FIG. 2, the carbon dioxide capture system 100A includes all the units depicted in the carbon dioxide capture system 100 in FIG. 1, and further includes a liquid desiccant reservoir 122 downstream of the absorber unit 105. The liquid desiccant reservoir 122 is configured to receive the second stream 120. The liquid desiccant reservoir 122 is in communication with the water vapor-generating unit 140 and the liquid desiccant regenerating unit 150 such that the water vapor-generating unit 140 and the liquid desiccant regenerating unit 150 receives a portion of the second stream 120. When regenerating the liquid desiccant of the second stream 120, the liquid desiccant regenerating unit 150 receives the second stream 120 from the liquid desiccant reservoir 122. When generating a water vapor stream using the second stream 120, the water vapor-generating unit 140 receives the second stream 120 from the liquid desiccant reservoir 122.

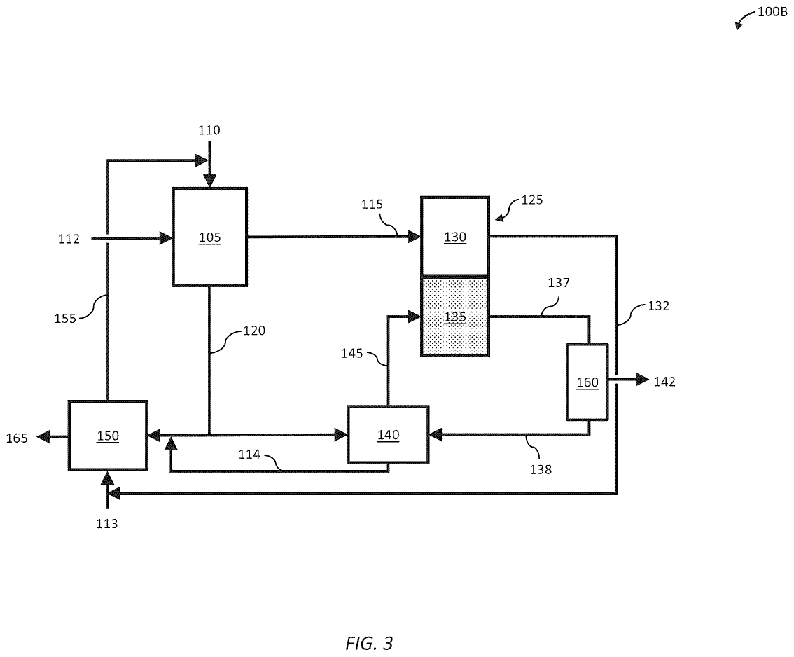

In some embodiments, the third stream produced by the carbon capture unit in regeneration mode may be further processed to extract the water for reuse by the carbon dioxide capture system. In some embodiments, as illustrated in FIG. 3, the carbon dioxide capture system 100B includes all the units described in FIG. 1 and further includes a separator 160 downstream of the carbon capture unit 125. The separator 160 is in fluid communication with the carbon capture unit 125 and is configured to receive the third stream 137 produced by the carbon capture unit 125 in regeneration mode. The separator 160 is configured to separate the water from the carbon dioxide in the third stream 137 and produce a carbon dioxide stream 142 and a water stream 138. The water stream 138 may be recirculated to the water vapor-generating unit 140. In some embodiments, the carbon dioxide capture system 100B may also include a liquid desiccant reservoir 122 as shown in FIG. 2.

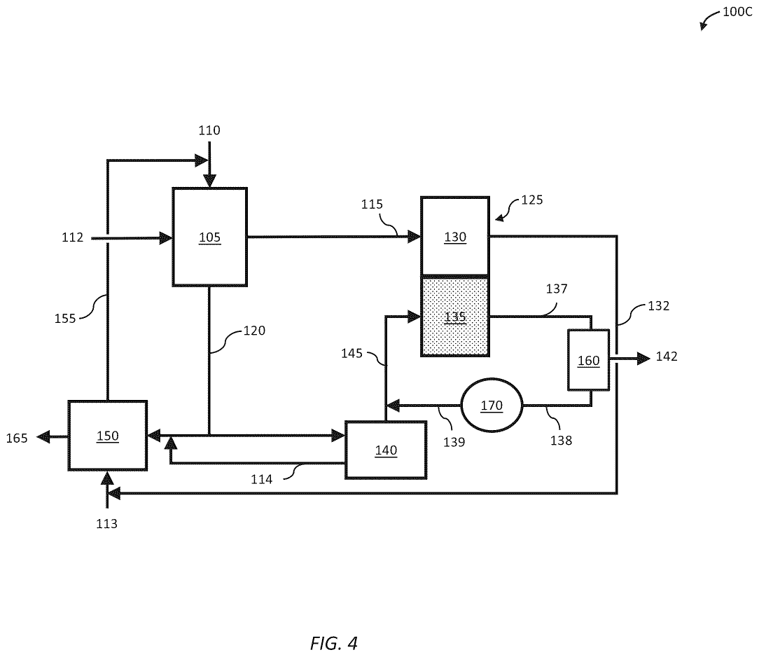

In some embodiments, the carbon dioxide capture system may further include a water-vapor producing unit, such as a steam flash unit for producing water vapor from the water separated out from the third stream. As depicted in FIG. 4, the carbon dioxide capture system 100C includes all the units described in FIG. 3 and further includes a steam flash unit 170 downstream and in communication with the separator 160 and is configured to receive the water stream 138 and generate a second water vapor stream 139. The second water vapor stream 139 is delivered to the carbon capture unit 125. In some embodiments, the carbon dioxide capture system 100C may also include a liquid desiccant reservoir 122 as shown in FIG. 2.

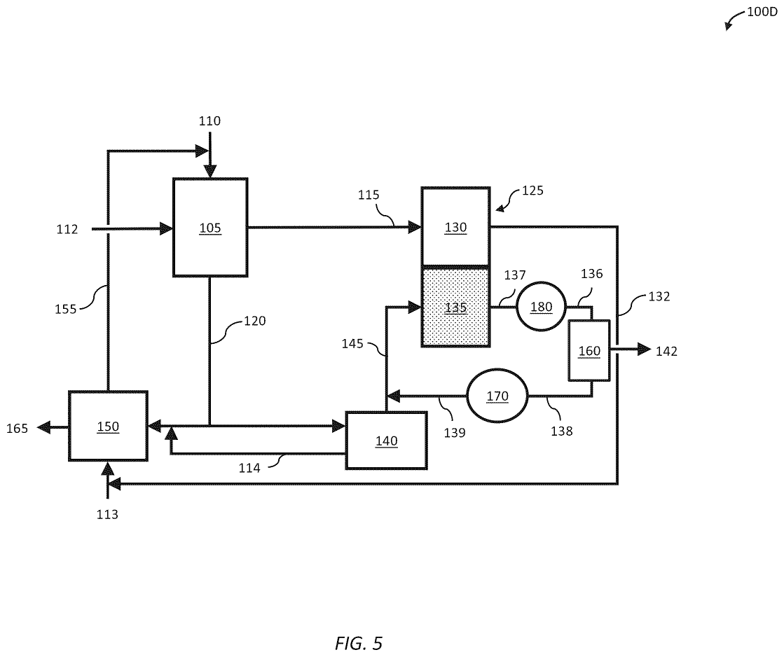

In some embodiments, the carbon dioxide capture system may further include a chiller between the carbon capture unit and the separator. As illustrated in FIG. 5, the carbon dioxide capture system 100D includes a chiller 180. The chiller 180 is in communication with the separator 160 and the carbon capture unit 125. The chiller 180 is configured to receive the third stream 137 and generate a chilled third stream 136. The separator 160 is configured to receive the chilled third stream 136. The chiller 180 can lower the temperature of the third stream and allow more water to be separated out in the separator 160. In some embodiments, the carbon dioxide capture system 100D may also include a liquid desiccant reservoir 122 as shown in FIG. 2.

In some embodiments, the liquid desiccant is an aqueous solution. In some embodiments, the liquid desiccant is an organic solution. In some embodiments, the liquid desiccant is selected from the group consisting of an inorganic salt aqueous solution, an organic salt aqueous solution, an organic pure liquid, an ionic liquid, and combinations thereof. In some embodiments, the inorganic salt aqueous solution is selected from the group consisting of lithium chloride, lithium bromide, zinc bromide, cesium fluoride, calcium chloride, magnesium chloride, calcium bromide, lithium iodide, potassium carbonate, magnesium nitrate, sodium bromide, potassium hydroxide, sodium hydroxide, and combinations thereof. In some embodiments, the organic salt aqueous solution is selected from the group consisting of potassium acetate, sodium acetate, potassium formate, sodium formate, and combinations thereof. In some embodiments, the organic pure liquid is selected from the group consisting of triethylene glycol, diethylene glycol, polyethylene glycol, propylene glycol, dipropylene glycol, glycerin, and combinations thereof. In some embodiments, the ionic liquid is selected from the group consisting of 1-ethyl-3-methylimidazolium acetate, 1-ethyl-3-methylimidazolium tetrafluoroborate, 1-ethyl-3-methylimidazolium diethylphosphate, 1-ethyl-3-methylimidazolium ethyl sulfate, 1-ethyl-3-methylimidazolium bis(trifluoromethanesulfonyl)imide, 1-hexyl-3-methylimidazolium acetate, 1-hexyl-3-methylimidazolium tetrafluoroborate, 1-hexyl-3-methylimidazolium methanesulfonate, 1-hexyl-3-methylimidazolium bis(trifluoromethanesulfonyl)imide, N-methyl-N-propylpyrrolidinium bis(trifluoromethanesulfonyl)imide, and combinations thereof.

In some embodiments, the liquid desiccant regenerating unit 150 is configured to receive the water lean liquid desiccant 114 from the water vapor-generating unit 140. The water lean liquid desiccant 114 has a lower water content than the water content of the second stream. In some embodiments, the carbon dioxide capture system further includes a dried liquid desiccant reservoir upstream of the absorber unit. In some embodiments, the dried liquid desiccant reservoir is configured to receive the dried liquid desiccant from the liquid desiccant regenerating unit.

In some embodiments, the absorber unit may include a packed bed tower, tray tower, spray tower, falling film tower, aeration tower, and porous or non-porous membrane contactor. In some embodiments, the liquid desiccant regenerating unit may include a packed bed tower, tray tower, spray tower, falling film tower, aeration tower, porous or non-porous membrane contactor, vertical or horizontal tube evaporator, agitated or wiped thin-film evaporator, reverse osmosis membrane unit, and an electrodialysis desalination unit.

In some embodiments, the moisture swing adsorbent used in the carbon capture unit can be a diverse range of porous materials that are unfunctionalized, such as mesoporous silica, zeolites and metal-organic frameworks, or functionalized versions of these same materials with carbonate (e.g. K₂CO₃), amines, hydroxyl groups, or strong basic or acid ion-exchange type chemicals, ionic liquids, and the like. For example, the amine-functionalized materials can include polymer-based inorganics like silica functionalized or coated with organic amines, or even metal-organic frameworks with amines in their linkers. The types of zeolites can also be very broad and are not limited to acidic zeolites, because non-acidic zeolites can also adsorb carbon dioxide.

### Method for Removing Carbon Dioxide From Ambient Air

The present disclosure provides a method for removing carbon dioxide from ambient air. In some embodiments of the present disclosure, the method includes feeding an ambient air stream into an absorber unit including a liquid desiccant. The ambient air stream comprises water and carbon dioxide. The liquid desiccant absorbs water in the ambient air stream to form a first stream having a water content less than the water content of the ambient air stream and a second stream comprising water removed from the ambient air stream and the liquid desiccant. The method further includes feeding the first stream to a carbon capture unit comprising a moisture swing adsorbent. The carbon capture unit can reversibly operate in capture mode and regenerating mode. The moisture swing adsorbent captures and removes carbon dioxide from the first stream, thereby forming a carbon dioxide-depleted dried air stream in capture mode. The method further includes feeding the second stream and a second ambient air stream, or the carbon dioxide-depleted dried air stream from the carbon capture unit to a liquid desiccant regenerating unit, thereby forming a dried liquid desiccant and a humid air stream. The humid air stream may exit the system, regenerating the liquid desiccant to form a dried liquid desiccant to be reused in the absorber unit.

In some embodiments, the method further includes regenerating the moisture swing adsorbent in the carbon capture unit by feeding a water vapor stream from a water vapor-generating unit. In some embodiments, the method further includes feeding the second stream to the water vapor-generating unit to produce or generate the water vapor stream. In some embodiments, the method further includes feeding the water vapor stream to the carbon capture unit and during regeneration mode, forming a third stream comprising carbon dioxide and water.

In some embodiments, the method further includes feeding the second stream, water from the third stream, or a combination thereof to the water vapor-generating unit. Feeding the second stream and/or the water from the third stream to the water vapor-generating unit regenerates the moisture swing adsorbent in the carbon capture unit. In some embodiments, the method further includes feeding the third stream into a separator to form a carbon dioxide stream and a water stream. The water stream may be delivered to the water vapor-generating unit or a steam flash unit to form a second water vapor stream for regenerating the moisture swing adsorbent in the carbon capture unit. In some embodiments, the method further includes feeding the third stream to a chiller prior to the separator. The chiller can help to condense water in the third stream into a liquid, lower the temperature of the third stream and allow more water to be separated out in the separator.

In some embodiments, the method further includes forming a water vapor stream by a vacuum reboiler, a plurality of pervaporation membranes, or a combination thereof. In some embodiments, the method further includes heating the liquid desiccant by the vacuum reboiler under vacuum to generate the water vapor stream. The heated liquid desiccant with less water content than the liquid desiccant of the second stream can be regenerated in the liquid desiccant regenerating unit. In some embodiments, the method further includes separating water from the liquid desiccant by partial vaporization through porous or non-porous pervaporation membranes. The separated liquid desiccant with less water content than the liquid desiccant of the second stream can be regenerated in the liquid desiccant regenerating unit.

What is claimed is:

1. A system comprising:
(a) an absorber unit comprising a liquid desiccant configured to receive an ambient air stream comprising water and carbon dioxide, and to absorb water from the ambient air stream to form (i) a first stream having a water content less than the water content of the ambient air stream and (ii) a second stream comprising water and the liquid desiccant;
(b) a carbon capture unit downstream of the absorber unit configured to receive the first stream, the carbon capture unit comprising a moisture swing adsorbent configured to reversibly operate in (i) capture mode to adsorb water and carbon dioxide from the first stream and produce a carbon dioxide-depleted dried air stream and (ii) regeneration mode to release adsorbed water and carbon dioxide to produce a third stream;
(c) a water vapor-generating unit in communication with the carbon capture unit configured to deliver a water vapor stream to the carbon capture unit during regeneration mode; and
(d) a liquid desiccant regenerating unit configured to receive (i) the second stream and (ii) ambient air, the carbon dioxide-depleted dried air stream from the carbon capture unit in capture mode, or a combination thereof and remove water from the second stream to produce (iii) a stream comprising dried liquid desiccant and (iv) a humid air stream comprising water removed from the second stream.

2. The system of claim 1, further comprising a liquid desiccant reservoir downstream of the absorber unit configured to receive the second stream from the absorber unit.

3. The system of claim 1, wherein the water vapor-generating unit comprises:
(a) a vacuum reboiler comprising a steam reservoir and a heater, wherein the vacuum reboiler is configured to receive the second stream, water generated by the carbon capture unit during regeneration mode, or a combination thereof; convert the water to water vapor; and deliver the water vapor to the carbon capture unit to regenerate the moisture swing adsorbent;
(b) a plurality of pervaporation membranes configured to receive the second stream, water generated by the carbon capture unit during regeneration mode, or a combination thereof; convert the water to water vapor; and deliver the water vapor to the carbon capture unit to regenerate the moisture swing adsorbent; or
(c) a combination thereof.

4. The system of claim 3, wherein the water vapor-generating unit comprises the vacuum reboiler configured to receive the second stream.

5. The system of claim 3, wherein the water vapor-generating unit comprises the vacuum reboiler configured to receive water from the carbon capture unit generated during regeneration mode.

6. The system of claim 3, wherein the water vapor-generating unit comprises the plurality of pervaporation membranes.

7. The system of claim 3, further comprising a separator configured to receive the third stream and produce a carbon dioxide stream and a water stream.

8. The system of claim 7, further comprising a chiller between the carbon capture unit and the separator.

9. The system of claim 7, further comprising a steam flash unit configured to receive the water stream from the separator and generate a second water vapor stream.

10. The system of claim 1, further comprising a dried liquid desiccant reservoir upstream of the absorber unit configured to receive the dried liquid desiccant from the liquid desiccant regenerating unit.

11. A method for removing water and carbon dioxide from an ambient air stream comprising:
(a) feeding an ambient air stream into an absorber unit comprising a liquid desiccant, wherein the liquid desiccant absorbs water in the ambient air stream to form a first stream having a water content less than the water content of the ambient air stream and a second stream comprising water and liquid desiccant;
(b) feeding the first stream to a carbon capture unit comprising a moisture swing adsorbent configured to capture water and carbon dioxide, thereby forming a carbon dioxide-depleted dried air stream; and
(c) feeding (i) the second stream and (ii) a second ambient air stream or the carbon dioxide-depleted dried air stream from the carbon capture unit to a liquid desiccant regenerating unit, thereby forming a dried liquid desiccant and humid air stream.

12. The method of claim 11, further comprising regenerating the moisture swing adsorbent in the carbon capture unit by feeding a water vapor stream from a water vapor-generating unit, thereby forming a third stream comprising water and carbon dioxide.

13. The method of claim 12, further comprising feeding the second stream, water from the third stream, or a combination thereof to the water vapor-generating unit.

14. The method of claim 13, further comprising:
feeding the third stream into a separator to form a carbon dioxide stream and a water stream; and
feeding the water stream to the water vapor-generating unit or a steam flash unit to form the water vapor stream for regenerating the moisture swing adsorbent.
